(19) United States
(12) Patent Application Publication
(10) Pub. No.: US 2026/0032149 A1
(43) Pub. Date: Jan. 29, 2026

(54) SYN COOKIE PROTECTION ACTIVATION

(71) Applicant: HEWLETT PACKARD ENTERPRISE DEVELOPMENT LP, Spring, TX (US)

(72) Inventors: Kranthi Kumar Damarla, Bangalore (IN); Ravikumar Govindarao, Bangalore (IN); Rupak Kumar Sahu, Bangalore (IN)

(21) Appl. No.: 18/894,283

(22) Filed: Sep. 24, 2024

(30) Foreign Application Priority Data
Jul. 24, 2024 (IN) 202441056316

(51) Int. Cl. H04L 9/40

(52) U.S. Cl. CPC H04L 63/1466

(57) ABSTRACT

In some examples, a proxy device tracks a count of how many half-open Transmission Control Protocol (TCP) flows are present in the proxy device. Based on the count breaching a threshold, the proxy device triggers activation, at the proxy device, of SYN cookie protection from an inactive state, where the SYN cookie protection includes generating an initial sequence number for a SYN-ACK packet based on applying a function on TCP state information associated with a received SYN packet from a client device. The SYN packet is to initiate a TCP flow between the client device and a server device, and the SYN-ACK packet is sent by the proxy device to the client device in response to the SYN packet.

### BACKGROUND

Electronic devices are able to communicate with one another over a network. The electronic devices can use various communication protocols to communicate data packets over the network. The Transmission Control Protocol (TCP) is a connection-based transport protocol that is used to establish a network connection between electronic devices so that data packets can be exchanged through the network connection.

### BRIEF DESCRIPTION OF THE DRAWINGS

Some implementations of the present disclosure are described with respect to the following figures.

FIG. 1 is a block diagram of an arrangement that includes a firewall device and various client and server devices connected to corresponding networks, in accordance with some examples.

FIG. 2 is a flow diagram of a process of a firewall device, according to some examples.

FIG. 3 is a block diagram of a storage medium storing machine-readable instructions according to some examples.

FIG. 4 is a block diagram of a proxy device according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the context of the Transmission Control Protocol (TCP), a client device establishes a connection with a server device. The client device establishes a connection with the server device by performing a handshake with the server device, where the handshake includes the client device sending a synchronize (SYN) packet to the server device, the server device responding with a synchronize-acknowledge (SYN-ACK) packet to the client device, and the client device sending an acknowledge (ACK) packet to the server device. Such a handshake is referred to as a 3-way handshake. The foregoing packets are examples of TCP packets (also referred to as TCP segments).

An attacker can initiate a TCP attack against a server device by performing a SYN flood attack. In the SYN flood attack, the attacker sends a large quantity of SYN packets to the server device, which can overwhelm the resources of the server device. The SYN flood attack results in a large number of half-open TCP flows at the server device. A half-open TCP flow is established when the server device receives a SYN packet and responds with a SYN-ACK packet. However, the attacker deliberately withholds the sending of the ACK packet to complete the establishment of a full TCP flow. The large number of half-open TCP flows consumes resources (including memory resources and processing resources) of the server device, since the server device has to store information representing the half-open TCP flows while waiting for receipt of corresponding ACK packets. A SYN flood attack is a form of a denial-of-service attack since the overwhelmed server device may no longer be able to perform normal operations, including setting up connections so that services of the server device can be accessed.

To avoid loss of service or having to implement a server device with increased resources (which can increase the cost of the server device), SYN cookie protection can be implemented at the server device to resist SYN flood attacks. If SYN cookie protection is implemented, the server device does not allocate resources (including memory) in response to receiving a SYN packet from a client device. Rather, the server device waits for the 3-way handshake to complete between the client device and the server device before allocating the resources at the server device.

However, SYN cookie protection may not be effective when implemented in a proxy device that is provided between client devices and server devices. An example of the proxy device is a firewall device that is used to protect devices (including the server devices) that sit behind the firewall device. If a SYN cookie mechanism is implemented at the proxy device, the proxy device has to perform certain operations, including sequence number translations, for sequence numbers used by the client devices and the server devices. The proxy device also has to restore TCP header parameters, such as a maximum segment size (MSS) (representing the largest TCP segment size that a device can receive) and other option values. Because sequence numbers are translated at the proxy device, the proxy device would also have to re-compute checksums, since checksums are based on the TCP packets (which include the translated sequence numbers). Sequence number translations and checksum re-computations consume processing resources at the proxy device. Moreover, computing SYN cookies are also associated with usage of processing resources in the proxy device, since SYN cookie computations involve encoding information and computing cryptographic hashes. As a result, a SYN flood attack lasting a long time may eventually wear out the proxy device by depleting available processing resources of the proxy device, which results in denial of service at the proxy device. For example, a firewall device may no longer be able to allow new sessions to be established through the firewall device if the resources of the firewall device are depleted.

In accordance with some implementations of the present disclosure, a dynamic SYN cookie protection mechanism is implemented at a proxy device to protect the proxy device against SYN flood attacks, where the dynamic SYN cookie protection mechanism maintains SYN cookie protection in an inactive state until a count of half-open TCP flows exceeds a threshold. In response to detecting that the count of half-open TCP flows exceeds the threshold, the proxy device activates SYN cookie protection from the inactive state. The dynamic SYN cookie protection mechanism selectively activates SYN cookie protection based on a condition of the proxy device, where the condition is based on how many half-open TCP flows have been established at the proxy device. Activating SYN cookie protection based on how many half-open TCP flows have been established at the proxy device is different from other example SYN cookie mechanisms that activate SYN cookie protection based on a count of SYN packets.

In a TCP 3-way handshake, the SYN packet is a TCP packet having a header with a SYN flag set to an active value (e.g., “1”). The SYN packet is sent from a client device to a server device to initiate a TCP flow between the client device and the server device. As used here, a “client device” refers to an electronic device that initiates a TCP connection (equivalently “TCP session” or “TCP flow”). A “server device” refers to an electronic device that is a target of a TCP connection establishment.

The header of the SYN packet also includes a sequence number field, which is set to an initial sequence number selected by the client device (e.g., selected randomly by the client device). The initial sequence number in the SYN packet is the sequence number of a first data byte to be sent by the client device. The client device includes a sequence number counter that starts with the initial sequence number and increments as additional data bytes are transmitted by the client device to the server device in a TCP connection established in response to the SYN packet. In some cases, a TCP packet includes a payload that can carry one or more data bytes. Note that TCP control packets such as SYN packets do not carry a payload.

In the TCP 3-way handshake, the server device responds to the SYN packet with a SYN-ACK (synchronize-acknowledge) packet, which is a TCP packet having a header with both a SYN flag and an ACK flag set to an active value (e.g., “1”). The SYN-ACK packet is both a SYN packet and an ACK packet to acknowledge the SYN packet from the client device. The header of the SYN-ACK packet includes a sequence number field containing the initial sequence number of the server device in the TCP connection, and an acknowledgment number field set to the initial sequence number of the SYN packet plus 1. Thus, if the initial sequence number in the SYN packet is A, then the acknowledgement number in the SYN-ACK packet is A+1.

The client device responds to the SYN-ACK packet by sending an ACK packet to the server device. The ACK packet is a TCP packet having a header with an ACK flag set to an active value (e.g., “1”) (note that the SYN flag in the ACK packet is set to an inactive value, such as “0”). The header of the ACK packet includes a sequence number field set to an acknowledgment number included in the SYN-ACK packet (e.g., A+1), and an acknowledgment number field set to the initial sequence number of the SYN-ACK packet plus 1. Thus, if the initial sequence number in the SYN-ACK packet is B, then the acknowledgement number in the ACK packet is B+1.

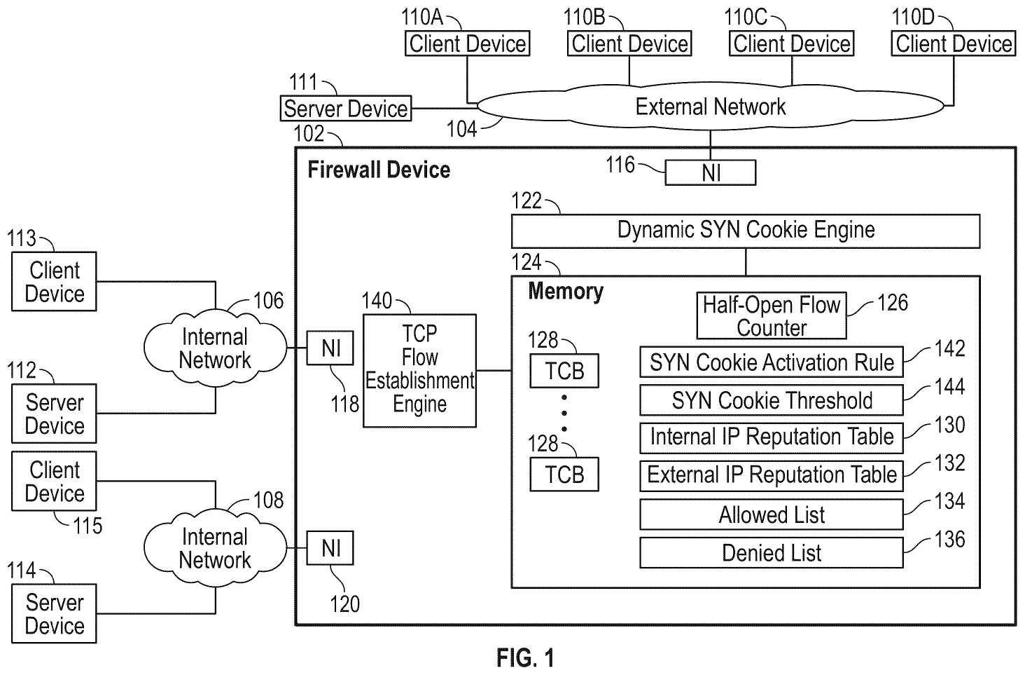

FIG. 1 is a block diagram of an example arrangement that includes a firewall device 102 that is connected between an external network 104 and internal networks 106 and 108. Although two internal networks are depicted in FIG. 1, in other examples, the firewall device 102 may be connected to just one internal network or more than two internal networks. Similarly, the firewall device 102 may be connected to more than one external network.

An internal network is a network that is protected against unauthorized access by devices without proper credentials or authorization information. Examples of an internal network can include a local area network (LAN), a wide area network (WAN), or another type of network. An external network refers to a network that is more widely accessible by electronic devices. An example of the external network 104 is the Internet, a WAN, or another type of network.

The firewall device 102 controls access to the internal networks 106 and 108. If the firewall device 102 determines that a client device is permitted to access an internal network, then a TCP flow establishment engine 140 in the firewall device 102 can establish a session (e.g., a TCP flow) between the client device and a server device on the internal network. For example, the TCP flow establishment engine 140 can establish a TCP flow between a client device (e.g., any of client devices 110A, 110B, 110C, and 110D) on the external network 104 and a server device 112 on the internal network 106 or a server device 114 on the internal network 108. As another example, the TCP flow establishment engine 140 can establish a TCP flow between a client device (e.g., client device 113 or 115) on an internal network (e.g., 106 or 108) and a server device (e.g., 114 or 112) on another internal network (e.g., 108 or 106). The determination of whether a client device is permitted to access an internal network can be based on credentials presented by the client device, a network address of the client device, and/or other information associated with the client device or a user of the client device. Additionally, the firewall device 102 can control access by an internal client device (e.g., 113 or 115) to an external server device 111 connected to the external network 104. The TCP flow establishment engine 140 can establish a TCP flow between the internal client device and the external server device 111.

Although FIG. 1 shows specific quantities of client devices and server devices connected to the various networks 104, 106, and 108, in other examples, different quantities (zero or more) client devices and server devices may be connected to the networks.

The firewall device 102 includes a network interface (NI) 116 that is connected to the external network 104, an NI 118 connected to the internal network 106, and an NI 120 connected to the internal network 108. A network interface includes a signal transceiver to transmit and receive signals over a network, and one or more communication protocol layers that manage the use of communication protocols on the network. The communication protocols include the Internet Protocol (IP) and the TCP.

The firewall device 102 includes a dynamic SYN cookie engine 122 according to some examples of the present disclosure. The dynamic SYN cookie engine 122 is able to selectively activate SYN cookie protection based on a count of how many half-open flows have been established in the firewall device 102.

The firewall device 102 includes a memory 124 accessible by the dynamic SYN cookie engine 122. The memory 124 can be implemented using one or more memory devices.

The memory 124 stores a half-open flow counter 126. The half-open flow counter 126 tracks how many half-open TCP flows are established in response to SYN packets from a client device (e.g., 110A, 110B, 110C, or 110D) and responsive SYN-ACK packets from a server device.

The TCP flow establishment engine 140 in the firewall device 102 can allocate a TCP control block (TCB) in the memory 124 to store TCP state information associated with a TCP flow. In the example of FIG. 1, TCBs 128 for respective TCP flows are stored in the memory 124. The TCB is established per TCP flow (a full TCP flow or a half-open TCP flow) established by the firewall device 102. Examples of TCP state information in a TCB 128 can include IP addresses and port numbers of the connection endpoints (client devices and server devices), a current round-trip time estimate, information of whether acknowledgment or retransmission is to be performed, statistics regarding the TCP flow, and/or other state information.

If SYN cookie protection is active, then the TCP flow establishment engine 140 does not allocate a TCB in response to receipt of a SYN packet from a given source IP address, such as the source IP address of a client device (e.g., any of 110A to 110D). The source IP address can be the IP address assigned to the client device, an NI in the client device, or a program in the client device. The program of the client device may be an application program or a virtual entity such as a virtual machine (VM) or a container.

Allocating a TCB in the memory 124 consumes memory resources of the firewall device 102. With SYN cookie protection active, the TCP flow establishment engine 140 allocates a TCB in response to establishment of a full TCP flow (i.e., after the 3-way handshake is completed).

However, if SYN cookie protection is inactive, the TCP flow establishment engine 140 allocates a TCB in response to a SYN packet from a given source IP address. If SYN cookie protection remains inactive, then the firewall device 102 may be vulnerable to a SYN flood attack. On the other hand, keeping SYN cookie protection active regardless of the condition of the firewall device 102 may also lead to resources of the firewall device 102 being overwhelmed if a large quantity of SYN cookies are created.

If the firewall device 102 becomes overwhelmed, then not only will the firewall device 102 not be able to establish further TCP flows for incoming requests from the external network 104, internal communications between client and server devices on the internal networks 106 and 108 may also be disrupted, since the firewall device would no longer be able to establish TCP flows between devices on the internal networks 106 and 108.

The dynamic SYN cookie engine 122 is able to selectively activate SYN cookie protection based on a current condition of the firewall device 102. In some examples, selective activation of SYN cookie protection for a given source IP address is based on comparing the count of the half-open flow counter 126 to a threshold. Once SYN cookie protection is activated, whether or not SYN cookie protection is actually performed can further be based on information in an IP reputation table and based on whether a limit on a quantity of SYN cookies has been violated (discussed further below). In some examples, the firewall device 102 stores an internal IP reputation table 130 and an external IP reputation table 132 in the memory 124.

The firewall device 102 can also store an allowed list 134 and a denied list 136. The allowed list 134 identifies source IP addresses that are allowed, i.e., creation of TCP flows in response to SYN packets from a source IP address in the allowed list 134 is allowed. The denied list 136 identifies source IP addresses that are to be blocked. If a source IP address in a TCP packet (including a SYN packet) is in the denied list 136, then the TCP packet is dropped by the firewall device 102 and no further action is taken by the firewall device 102 in response to the TCP packet. A “list” can include any collection of source IP addresses. The list can be in the form of a file, a table, or any other object.

### SYN Cookie Protection

If SYN cookie protection is to be applied for a given source IP address of a given client device, the dynamic SYN cookie engine 122 creates a SYN cookie in response to receiving a SYN packet from the given source IP address. The SYN cookie includes encoded data (e.g., cryptographically hashed data) stored in the memory 124. The SYN cookie encodes specified TCP state information from the SYN packet so that the firewall device 102 does not have to allocate a TCB 128 to hold the specified information while waiting for the ACK in the 3-way handshake triggered by the SYN packet. In some examples, the specified TCP state information includes a maximum segment size (MSS) included in the header of the SYN packet. The MSS specifies the largest quantity of data bytes that can be received in a TCP packet. In further examples, the SYN cookie can encode additional or alternative TCP state information of the SYN packet, such as a source IP address, a destination IP address, a source TCP port, a destination TCP port, and/or SYN sequence number.

The encoding of the specified TCP state information from the SYN packet involves applying an encoding function on the specified TCP state information. An encoding function can include a hash function, such as a Secure Hash Algorithm (SHA) function, a hash-based message authentication code (HMAC) function, an MD5 message digest hash function, or another type of hash function. The encoded information forms an initial sequence number of the SYN-ACK packet sent by the firewall device 102 to the given client device in the 3-way handshake. This initial sequence number of the SYN-ACK packet is referred to as a “cookie initial sequence number” since the initial sequence number is based on applying an encoding function on information in the SYN packet instead of the firewall device 102 selecting a random initial sequence number to include in the SYN-ACK packet. Subsequently, the firewall device 102 can receive an ACK packet from the given client device. If the ACK packet contains an acknowledgment number that is equal to the cookie sequence number plus 1, then the firewall device 102 verifies that the given client device is a legitimate client device (as opposed to an attacker). The firewall device 102 can then decode the acknowledgment number (cookie sequence number plus 1) to re-create the specified information (e.g., MSS) of the SYN packet. At this point, the firewall device 102 allocates a TCB 128 to store the specified information as well as other information for the TCP flow. The firewall device 102 further initiates a 3-way handshake with a target server device to which the given client device seeks to connect. The 3-way handshake between the firewall device 102 and the server device includes the firewall device 102 sending a SYN packet to the target server device, the server device responding with a SYN-ACK packet, and the firewall device 102 sending an ACK packet to the target server device. Once the 3-way handshake with the server device is completed, a TCP connection is established between the given client device and the target server device. Effectively, for establishment of the TCP connection between the given client device and the target server device, the firewall device 102 is a proxy device that (1) performs a first 3-way handshake between the given client device and the firewall device 102, and (2) performs a second 3-way handshake between the firewall device 102 and the target server device. The firewall device 102 translates the sequence and acknowledgement numbers for each TCP packet transferred between a client device and a server device until the TCP session is terminated.

### Selective Activation of SYN Cookie Protection

As noted above, selective activation of SYN cookie protection is based on the count of the half-open flow counter 126. The dynamic SYN cookie engine 122 uses a SYN cookie activation rule 142 (stored in the memory 124) to determine whether or not SYN cookie protection is to be activated. An example of the SYN cookie activation rule 142 is set forth in Table 1 below.

TABLE 1

| | | | Lower | | Upper |
|---|---|---|---|---|---|
| | | Lower | Thresh- | Upper | Thresh- |
| | | Thresh- | old | Thresh- | old |
| Zone | Metric | old | Action | old | Action |
| External | Quantity | 10,000 | Alert | 200,000 | Activate |
| Network | of half- | | and/or | | SYN |
| | open TCP | | Rapid | | Cookie |
| | flows | | Aging | | |

This example SYN cookie activation rule 142 specifies a zone for which SYN cookie protection is to be applied. A zone can refer to a network area that includes various resources, such as server devices, client devices, programs, etc. The zone specified in the example SYN cookie activation rule 142 is an external network zone including resources on the external network 104. SYN cookie protection would not be applied to internal network zones in this example. In other examples, SYN cookie protection may be applied to an internal network zone (e.g., including either the internal network 106 or 108).

The example SYN cookie activation rule 142 also specifies that the metric to be monitored for triggering SYN cookie protection activation is the quantity of half-open TCP flows. The example SYN cookie activation rule 142 further specifies a lower threshold and an upper threshold against which the quantity of half-open TCP flows is to be compared. The lower and upper thresholds can be set by an administrator, a program, or a machine to any of various different values. In other examples, just one threshold or more than two thresholds may be specified in the SYN cookie activation rule 142.

According to the SYN cookie activation rule 142, if the quantity of half-open TCP flows exceeds the lower threshold but is less than the upper threshold (e.g., in a given time duration), then the dynamic SYN cookie engine 122 can perform any of various designated lower threshold actions, including issuing an alert and/or performing rapid aging. The alert can be issued to a target entity (e.g., a human, a program, or a machine) indicating that a relatively large quantity (e.g., 10,000 or more) of half-open TCP flows has been detected.

The rapid aging action includes reducing a flow inactivity timeout value (represented by a configuration parameter) for a half-open TCP flow. After a half-open TCP flow is established at the firewall device 102 and a TCB 128 has been allocated, the TCP flow establishment engine 140 starts an inactivity timer for the half-open TCP flow to track a time duration of inactivity. If the inactivity timer exceeds the flow inactivity timeout value (which means that no activity has been detected during a timeout interval), then the TCP flow establishment engine 140 removes the allocated TCB 128 so that memory space is freed up in the memory 124 for other TCBs. Effectively, the TCP flow establishment engine 140 accesses the configuration parameter representing a flow inactivity timeout duration, and terminates a given half-open TCP flow based on the given half-open TCP flow being inactive for the flow inactivity timeout duration.

If the quantity of half-open TCP flows exceeds the lower threshold but is less than the upper threshold, the rapid aging action reduces the flow inactivity timeout value so that TCB removal occurs more quickly. For example, if the flow inactivity timeout value is initially set at 120 seconds(s) (or some other initial value), then rapid aging can reduce the flow inactivity timeout value to 60 s (or some other lower value less than the initial value).

If the quantity of half-open TCP flows for a given source exceeds the upper threshold,) then the dynamic SYN cookie engine 122 activates SYN cookie protection for the external network zone (an example of an upper threshold action).

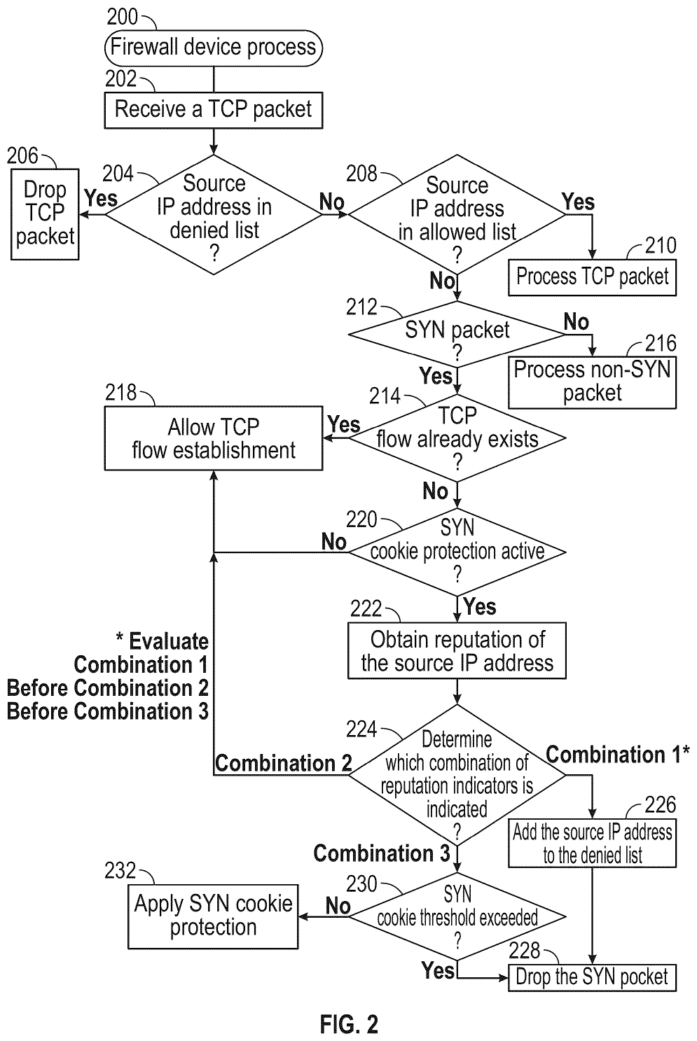

Note that SYN cookie protection being active in the firewall device 102 does not mean that SYN cookie protection is applied to a SYN packet from any particular source IP address. In other words, even if SYN cookie protection is active, it may still be possible for SYN cookie protection to not be applied to a received SYN packet. More specifically, if SYN cookie protection is active in the firewall device 102, then the dynamic SYN cookie engine 122 further considers other information for the particular source IP address, including whether the particular source IP address is in the allowed list 134 or the denied list, and what reputation (if any) is assigned the particular source IP address in an IP reputation table, including the internal IP reputation table 130 and/or the external IP reputation table 132. Such further consideration to determine whether or not to apply SYN cookie protection is referred to as a “SYN cookie application challenge” (which in some examples includes tasks 222, 224, 226, 228, 230, and 232 of FIG. 2 discussed further below).

### Information Used for Dynamic SYN Cookie Protection

As noted above, the dynamic SYN cookie engine 122 uses the following information in selectively activating and applying SYN cookie protection: the half-open flow counter 126, the internal IP reputation table 130, the external IP reputation table 132, the allowed list 134, the denied list 136, and a SYN cookie threshold 144 that specifies an upper limit on a quantity of SYN cookies created in the firewall device 102.

In some examples, the dynamic SYN cookie engine 122 increments the half-open flow counter 126 based on detecting a half-open TCP flow that satisfies the following criteria: (1) a SYN packet received by the firewall device 102 from a client device and a SYN-ACK packet sent from a server device and forwarded by the firewall device 102 to the client device; (2) a reset (RST) packet has not been received from the client device at the firewall device 102 in the TCP flow within a specified time duration of transmission of the SYN-ACK packet (e.g., 2 seconds or a different duration), in other words, the specified time duration has elapsed from a transmission time of the SYN-ACK packet and the firewall device 102 has not received a transmission of the RST packet); and (3) an ACK has not been received from the client device at the firewall device 102 in the TCP flow within the specified time duration of transmission of the SYN-ACK packet. The foregoing four criteria for incrementing the half-open flow counter 126 are referred to as “criteria (1)-(3).” A RST packet is a TCP packet having a header with a RST flag set to an active value (e.g., “1”).

As half-open TCP flows are removed, the half-open flow counter 126 can be decremented. Although some examples increment the half-open flow counter 126 with detected half-open TCP flows, in other examples, the half-open flow counter 126 can be decremented from an initial high value as half-open TCP flows are detected. As used here, “advancing” a counter can refer to incrementing the counter or decrementing the counter.

The dynamic SYN cookie engine 122 is responsible for creating and maintaining the internal IP reputation table 130. The internal IP reputation table 130 correlates source IP addresses to reputation indicators that can be set to any of various different values to indicate different reputation levels. For example, a reputation indicator can be set to a first value to indicate a “bad” reputation, a second value to indicate an “unknown” reputation, and a third value to indicate a “good” reputation. Although three discrete values are listed, in other examples, more than three values can be assigned to a reputation indicator to represent more than three reputation levels, or alternatively, a reputation indicator can be assigned to a numerical score that can vary continuously within a range.

A source IP address having a “bad” reputation is one that has been determined to be more likely to be a malicious actor than a source IP address having a “good” reputation. A source IP address has an “unknown” reputation if an insufficient amount of information has been obtained to make a determination of whether the source IP address is likely a malicious actor or unlikely to be a malicious actor.

An example internal IP reputation table 130 is represented in Table 2 below.

TABLE 2

| | | Total | Quantity of | Internal |
|---|---|---|---|---|
| Source IP | Start | Quantity of | Half-Open | IP |
| Address | Time | TCP Flows | TCP Flows | Reputation |
| 150.1.74.23 | T1 | 25 | 25 | Bad |
| 162.43.8.4 | T2 | 42 | 42 | Bad |
| 165.76.234.67 | T3 | 2 | 2 | Unknown |
| 10.34.84.2 | T4 | 73 | 0 | Good |

The “Start Time” column represents a receipt time of a SYN packet, which is the time that the respective source IP address was first observed by the firewall device 102. The “Total Quantity of TCP Flows’ column represents a total quantity of TCP flows involving the respective source IP address. The “Quantity of Half-Open Flows” column represents a quantity of half-open TCP flows. The “Internal IP Reputation” column represents an inferred IP reputation determined based on observed traffic involving the respective source IP address.

Instead of being in the form of a table, reputation indicators of source IP addresses can be stored in other types of reputation data structures, such as in the form of text files, trees, and so forth.

When the firewall device 102 starts up (such as due to a power on from a lower power state or a power off state or due to a reboot or reset), initially all newly encountered source IP addresses have an “unknown” reputation until further traffic is observed for such source IP addresses. A “newly encountered” source IP address refers to a source IP address not already included in the internal IP reputation table 130.

In response to receiving a SYN packet with a newly encountered source IP address (e.g., source IP Addr_Y), the dynamic SYN cookie engine 122 creates a new entry (e.g., entry Y) in the internal IP reputation table 130, and sets the reputation indicator in entry Y to the second value to indicate that source IP Addr_Y has the “unknown” reputation.

The dynamic SYN cookie engine 122 can change the reputation indicator in entry Y as follows. If the dynamic SYN cookie engine 122 detects that source IP Addr_Y has successfully established M (M≥1) quantity of consecutive full TCP flows (a full TCP flow has completed the 3-way handshake discussed above), then the dynamic SYN cookie engine 122 can change the reputation indicator in entry Y of the internal IP reputation table 130 to the third value to indicate a “good” reputation. The value of M can be set by an administrator, a program, or a machine, and can be statically set or dynamically varied. The establishment of M consecutive full TCP flows with source IP Addr_Y indicates that source IP Addr_Y is a source of genuine traffic.

If the dynamic SYN cookie engine 122 detects that source IP Addr_Y has successfully established N (N≥1) quantity of consecutive non-established TCP flows that satisfy criteria (1)-(3) as discussed above, then the dynamic SYN cookie engine 122 can change the reputation indicator in entry Y of the internal IP reputation table 130 to the first value to indicate a “bad” reputation. A “non-established” TCP flow refers to a TCP flow which has not been fully established according to the 3-way handshake. The value of N (which can be the same as or different from M) can be set by an administrator, a program, or a machine, and can be statically set or dynamically varied. The establishment of N consecutive non-established TCP flows with source IP Addr_Y indicates that source IP Addr_Y is a potentially an attacker.

Note that the reputation indicator in each entry of the internal IP reputation table 130 is continually updated by the dynamic SYN cookie engine 122 based on observed traffic associated with a respective source IP address.

The dynamic SYN cookie engine 122 can also create and maintain the external IP reputation table 132. The external IP reputation table 132 correlates source IP addresses to reputation indicators that can be set to any of various different values to indicate different reputation levels, such as the “bad” reputation, the “unknown” reputation, and the “good” reputation. The reputation indicators are set by the dynamic SYN cookie engine 122 in response to reputation information provided by one or more reputation service providers that are separate from the firewall device 102. A reputation service provider provides an IP reputation service that includes determining a reputation of a source IP address based on various factors such as historical behavior, spam reports, malware activity, and/or other factors.

The external IP reputation table 132 can include entries, where each entry contains a source IP address and a reputation indicator set based on information from one or more reputation service providers. Instead of being in the form of a table, the external IP reputation table 132 can have another form, such as a text file, a tree, and so forth.

Note that the reputation indicator in each entry of the external IP reputation table 132 is continually updated by the dynamic SYN cookie engine 122 based on reputation information received from the one or more reputation service providers.

In some examples, the internal and external IP reputation tables 130 and 132 are not used by the dynamic SYN cookie engine 122 in determining what to do with an incoming SYN packet if SYN cookie protection is inactive.

However, if SYN cookie protection is active, the reputation of a source IP address (from the internal and external IP reputation tables 130 and 132) is used to determine whether to (a) block a SYN packet (by adding the given source IP address to the denied list 136), or (b) allow a TCP flow to be created in response to the SYN packet, or (c) perform a SYN cookie application determination to determine whether to apply the SYN cookie protection

The denied list 136 is maintained by the dynamic SYN cookie engine 122 based on reputation indicators of source IP addresses. If either the internal IP reputation table 130 or the external IP reputation table 132 indicates a given source IP address as having a “bad” reputation, then the given source IP address is added by the dynamic SYN cookie engine 122 to the denied list 136. Any packets from a source IP address in the denied list is dropped for a specified time interval. The denied list 136 (or entries in the denied list 136) can also be provided by an administrator, a program, or a machine. The denied list 136 includes untrusted IP addresses that may be bogus or malicious.

The allowed list 134 can also be provided by an administrator, a program, or a machine. The allowed list 134 includes trusted source IP addresses. SYN cookie protection is bypassed for SYN packets from source IP addresses in the allowed list. This ensures that entities assigned trusted source IP addresses can access an internal network without being subjected to SYN cookie processing.

The SYN cookie threshold 144 is stored in the memory 124. The SYN cookie threshold 144 may be received from an administrator, a program, or a machine. The SYN cookie threshold 144 can restrict the quantity of SYN cookies generated per unit time. Any incoming SYN packet that would cause the SYN cookie threshold 144 to be violated would be dropped. Restricting the quantity of SYN cookies generated per unit time can reduce resource consumption at the firewall device 102 during an attack.

FIG. 2 is a flow diagram of a firewall device process 200 according to some examples. The firewall device 102 receives (at 202) a TCP packet from a source client device. The TCP packet 202 has a header containing a source IP address and a destination IP address of a target server device. The firewall device 102 determines (at 204) whether the source IP address is in the denied list 136, by comparing the source IP address in the received TCP packet with source IP addresses (if any) in the denied list 136. If the source IP address in the received TCP packet is in the denied list 136, then the firewall device 102 drops (at 206) the received TCP packet.

If the source IP address in the received TCP packet is not in the denied list 136, then the firewall device 102 determines (at 208) whether the source IP address in the received TCP packet is in the allowed list 134. This determination is performed by comparing the source IP address of the received TCP packet with source IP addresses (if any) in the allowed list 134. If the source IP address of the received TCP packet is in the allowed list 134, then the firewall device 102 processes (at 210) the received TCP packet, which can include allocating a TCB in memory if not already created. If the received TCP packet is a SYN packet, then the processing (at 210) includes the following. The firewall device 102 forwards the SYN packet to the target server device (identified by the destination IP address in the SYN packet), and if session creation is successful at the target server device, the firewall device 102 receives a SYN-ACK packet sent by the target server device in response to the SYN packet, which would result in creating a half-open TCP flow. The firewall device 102 sends the SYN-ACK packet from the target server device to the source client device.

If the firewall device 102 determines (at 208) that the source IP address in the received TCP packet is not in the allowed list 134, the firewall device 102 determines (at 212) whether the received TCP packet is a SYN packet. If so, the process continues to task 214. However, if the received TCP packet is not a SYN packet, then different processing is applied (at 216) to the non-SYN packet.

If the received TCP packet is a SYN packet (referred to as a “received SYN packet”), the dynamic SYN cookie engine 122 determines (at 214) whether a TCP flow corresponding to the received SYN packet already exists. In an example, the received SYN packet may be a retransmitted SYN packet, which means that a prior instance of the SYN packet was previously received and a TCP flow has already been established based on the prior instance of the SYN packet. However, a SYN-ACK packet sent by the firewall device 102 in response to the prior instance of the SYN packet was not successfully delivered to the client device that sent the prior instance of the SYN packet, which caused the client device to retransmit the SYN packet. If the dynamic SYN cookie engine 122 determines (at 218) that the TCP flow corresponding to the received SYN packet already exists, the dynamic SYN cookie engine 122 allows (at 218) the TCP flow establishment engine 140 to continue with TCP flow establishment (such as by establishing a full TCP flow if an ACK is received at the firewall device 102).

If the dynamic SYN cookie engine 122 determines (at 214) that the TCP flow corresponding to the received SYN packet does not already exist, the dynamic SYN cookie engine 122 determines (at 220) whether SYN cookie protection is active. If SYN cookie protection is inactive, the dynamic SYN cookie engine 122 allows (at 218) the TCP flow establishment engine 140 to continue with TCP flow establishment, such as by setting up a half-open TCP flow if the received SYN packet is a first instance of the SYN packet.

However, if the dynamic SYN cookie engine 122 determines (at 220) that SYN cookie protection is active, the dynamic SYN cookie engine 122 obtains (at 222) the reputation of the source IP address of the received SYN packet by retrieving reputation indicators (if any) from the internal and external IP reputation tables 130 and 132. Note that if the source IP address of the received SYN packet is a newly encountered source IP address in either the internal IP reputation table 130 or the external IP reputation table 132, the dynamic SYN cookie engine 122 adds a new entry containing the source IP address to the internal IP reputation table 130, and marks the added source IP address as having an “unknown” reputation.

The dynamic SYN cookie engine 122 determines (at 224) which of the following combinations of reputation indicators from the internal and external IP reputation tables 130 and 132 is indicated. The three combinations listed below are evaluated in the given order, i.e., determine if Combination 1 is true, and if not, determine if Combination 2 is true, and if not, Combination 3 is true.

Combination 1: internal “bad” reputation or external “bad” reputation (i.e., the internal IP reputation table 130 indicates that the source IP address of the received SYN packet has the “bad” reputation, or the external IP reputation table 132 indicates that the source IP address of the received SYN packet has the “bad” reputation).

Combination 2: internal “good” reputation or external “good” reputation (i.e., the internal IP reputation table 130 indicates that the source IP address of the received SYN packet has the “good” reputation, or the external IP reputation table 132 indicates that the source IP address of the received SYN packet has the “good” reputation).

Combination 3: internal “unknown” reputation and external “unknown” reputation (i.e., the internal IP reputation table 130 indicates that the source IP address of the received SYN packet has the “unknown” reputation, and the external IP reputation table 132 indicates that the source IP address of the received SYN packet has the “unknown” reputation). Combination 3 is indicated if neither combination 1 nor combination 2 applies.

If Combination 1 is encountered, the dynamic SYN cookie engine 122 adds (at 226) the source IP address of the received SYN packet to the denied list 136, and drops (at 228) the received SYN packet. Note that once the source IP address of the received SYN packet is added to the denied list 136, any further TCP packet containing the source IP address would be dropped, which effectively blocks traffic from the source IP address. The source IP address can be blocked for a specified block time duration, after which the source IP address can be removed from the denied list 136. The block time duration for the source IP address can be exponentially increased with the number of times that the source IP address is added to the denied list 136. For example, if the source IP address is added to the denied list 136 for the first time, the firewall device 102 sets a first block time duration (Block_Time). However, if the source IP address is added to the denied list 136 for the R^{th} (R>1) time, then the firewall device 102 sets a block time duration that is an exponential factor of Block_Time, such as 2^{R}·Block_Time.

If Combination 2 is encountered, the dynamic SYN cookie engine 122 allows (at 218) the TCP flow establishment engine 140 to continue with TCP flow establishment, such as by performing a TCB allocation and setting up a TCP flow if the received SYN packet is a first instance of the SYN packet. This effectively bypasses applying SYN cookie protection even though SYN cookie protection is active.

If Combination 3 is encountered, the dynamic SYN cookie engine 122 determines (at 230) whether setting up another SYN cookie responsive to the received SYN packet would cause the quantity of SYN cookies to exceed the SYN cookie threshold 144. If so, the dynamic SYN cookie engine 122 drops (at 228) the received SYN packet.

If setting up another SYN cookie responsive to the received SYN packet would not cause the quantity of SYN cookies to exceed the SYN cookie threshold 144, the dynamic SYN cookie engine 122 applies (at 232) SYN cookie protection, which includes generating a SYN cookie for the received SYN packet and proceeding with the process discussed in the “SYN COOKIE PROTECTION” section above.

Performing the SYN cookie application challenge (which in some examples includes tasks 222, 224, 226, 228, 230, and 232) reduces the number of SYN cookies generation by the firewall device 102, to reduce the computation overhead associated with SYN cookie generation and processing. SYN packets with source IP addresses having a “bad” reputation are dropped without further processing. Further, TCP flow establishments are allowed for SYN packets with a “good” reputation, which bypasses SYN cookie application. Note that the firewall device 102 would also not generate a SYN cookie if a source IP address of a SYN packet is: (1) in the allowed list 134 (processing of such a SYN packet is allowed irrespective of reputation), or (2) in the denied list 136 (such a SYN packet would be dropped by the firewall device 102).

Also, by setting a threshold on the quantity of half-open TCP flows before SYN cookie protection is activated, the firewall device 102 does not prematurely waste resources in applying SYN cookie protection in scenarios where there is a legitimate surge of SYN traffic, such as when a server device on an internal network starts again after being down for a brief period of time, or in other scenarios where a surge in SYN traffic is expected.

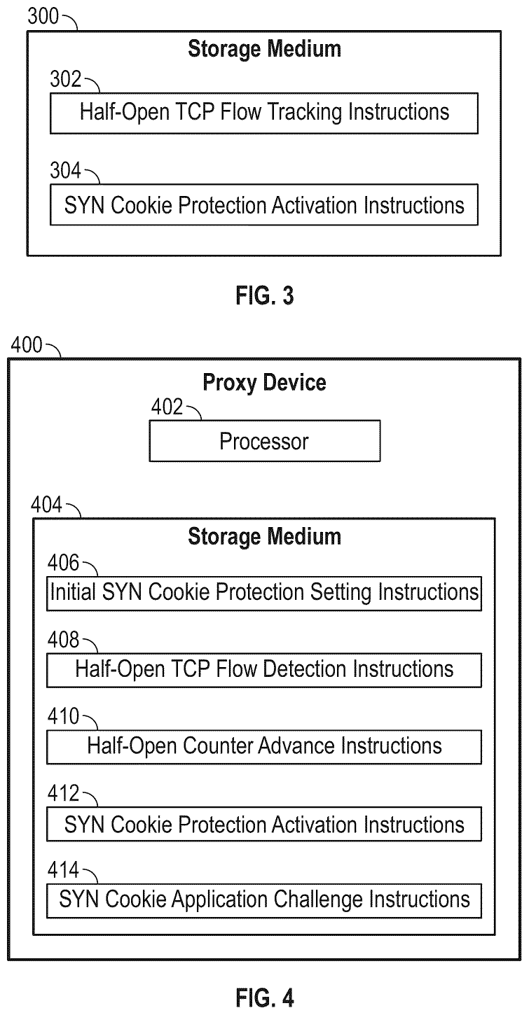

FIG. 3 is a block diagram of a non-transitory machine-readable or computer-readable storage medium 300 storing machine-readable instructions that upon execution cause a proxy device to perform various tasks. An example of the proxy device is the firewall device 102 of FIG. 1.

The machine-readable instructions include half-open TCP tracking instructions 302 to track a count of how many half-open TCP flows are present in the proxy device. The tracking can be performed using the half-open flow counter 126 of FIG. 1, for example. The half-open flow counter is advanced (incremented or decremented) with each detection of a new half-open TCP flow.

The machine-readable instructions include SYN cookie protection activation instructions 304 to, based on the count breaching a threshold, trigger activation, at the proxy device, of SYN cookie protection from an inactive state. The count breaching the threshold can refer to the count exceeding the threshold or dropping below the threshold. The SYN cookie protection includes generating an initial sequence number for a SYN-ACK packet based on applying a function (e.g., an encoding function) on TCP state information associated with a received SYN packet from a client device, the SYN packet to initiate a TCP flow between the client device and a server device through the proxy device, and the SYN-ACK packet sent by the proxy device to the client device in response to the SYN packet.

In some examples, the proxy device detects a half-open TCP flow based on receiving a first SYN packet at the proxy device from a first source IP address of the client device, sending a responsive SYN-ACK packet from a server device, and determining that an ACK packet responsive to the SYN-ACK packet has not been received at the proxy device.

In some examples, the proxy device detects the half-open TCP flow further based on determining that the proxy device has not received a reset within a specified time duration from a transmission time of the SYN-ACK packet.

In some examples, the proxy device maintains the SYN cookie protection in the inactive state at the proxy device responsive to the count not breaching the threshold. When the SYN cookie protection is in the inactive state, the proxy device allows a creation of a new half-open TCP flow in response to receiving a SYN packet.

In some examples, the proxy device accesses a configuration parameter representing a half-open TCP flow inactive timeout duration, and the proxy device terminates a given half-open TCP flow based on the given half-open TCP flow being inactive for the half-open TCP flow inactive timeout duration.

In some examples, the proxy device maintains first reputation information for source IP addresses, the first reputation information correlating the source IP addresses to respective reputation indicators. For example, the first reputation table includes the internal IP reputation table 130 of FIG. 1. The proxy device updates a first reputation indicator for a first source IP address in the first reputation information based on a quantity of full TCP flows established with the first source IP address or a quantity of non-established TCP flows with the first source IP address.

In some examples, the updating of the first reputation indicator includes setting the first reputation indicator to indicate a positive reputation (e.g., a “good” reputation) for the first source IP address responsive to detecting a specified quantity of consecutive full TCP flows established with the first source IP address.

In some examples, the proxy device allows a creation of a new TCP flow with the first source IP address responsive to the first reputation indicator indicating the positive reputation.

In some examples, the updating of the first reputation indicator includes setting the first reputation indicator to indicate a negative reputation (e.g., a “bad” reputation) for the first source IP address responsive to detecting a specified quantity of consecutive non-established TCP flows with the first source IP address.

In some examples, the proxy device drops a SYN packet from the first source IP address responsive to the first reputation indicator indicating the negative reputation.

In some examples, the proxy device adds the first source IP address to a denied list (e.g., 136 in FIG. 1) of source IP addresses responsive to the first reputation indicator indicating the negative reputation.

In some examples, the updating of the first reputation indicator includes setting the first reputation indicator to indicate an unknown reputation for the first source IP address. The proxy device applies SYN cookie protection for a SYN packet received from the first source IP address if the first reputation indicator is set to indicate the unknown reputation.

In some examples, the proxy device maintains second reputation information that correlates source IP addresses to respective reputation indicators based on information from one or more IP reputation services. The second reputation information can include the external IP reputation table 132 of FIG. 1, for example. The proxy device uses the second reputation information to determine whether to: allow creation of a new TCP flow with the first source IP address, or apply SYN cookie protection for a SYN packet received from the first source IP address, or drop the SYN packet from the first source IP address.

In some examples, the proxy device determines whether a quantity of generated SYN cookies has exceeded a threshold. Based on determining that the quantity of generated SYN cookies has exceeded the threshold, the proxy device drops a SYN packet.

In some examples, based on the count being greater than a second threshold but less than the first threshold, the proxy device activates rapid aging of a half-open TCP flow established in response to a SYN packet, where the rapid aging reduces a flow inactivity timeout value that triggers termination of the half-open TCP flow if the half-open TCP flow has been inactive for a time duration represented by the flow inactivity timeout value.

FIG. 4 is a block diagram of a proxy device 400 according to some examples. The proxy device 400 may include the firewall device 102 of FIG. 1 in an example.

The proxy device 400 includes a hardware processor 402 (or multiple hardware processors). A hardware processor can include a microprocessor, a core of a multi-core microprocessor, a microcontroller, a programmable integrated circuit, a programmable gate array, or another hardware processing circuit.

The proxy device 400 includes a storage medium 404 storing machine-readable instructions executable on the hardware processor 402 to perform various tasks. Machine-readable instructions executable on a hardware processor can refer to the instructions executable on a single hardware processor or the instructions executable on multiple hardware processors.

The machine-readable instructions in the storage medium 404 include initial SYN cookie protection setting instructions 406 to initially set SYN cookie protection in the proxy device to an inactive state.

The machine-readable instructions in the storage medium 404 include half-open TCP flow detection instructions 408 to detect a half-open TCP flow. The detection of the half-open TCP is based on failing to receive an ACK packet, and/or a RST packet as discussed further above.

The machine-readable instructions in the storage medium 404 include half-open counter advance instructions 410 to advance a half-open flow counter based on detecting the half-open TCP flow. Advancing the half-open flow counter can include incrementing the half-open counter or decrementing the half-open counter.

The machine-readable instructions in the storage medium 404 include SYN cookie protection activation instructions 412 to, based on a count of the half-open flow counter breaching a threshold, activate the SYN cookie protection to an active state from the inactive state.

The machine-readable instructions in the storage medium 404 include SYN cookie application challenge instructions 414 to, based on the SYN cookie protection being in the active state, perform a SYN cookie application challenge that determines whether to apply the SYN cookie protection based on a reputation of a source IP address in a SYN packet received from a client device to initiate a TCP flow between the client device and a server device. The reputation can be determined based on the internal IP reputation table 130 and/or the external IP reputation table 132, for example.

In some examples, based on the SYN cookie protection being in the active state, the proxy device performs the SYN cookie application challenge that determines whether to apply the SYN cookie protection further based on whether a threshold (e.g., 144 in FIG. 1) on a quantity of SYN cookies is violated. Note that the proxy device 400 also does not generate a SYN cookie if a source IP address of a SYN packet is: (1) in the allowed list 134 (processing of such a SYN packet is allowed irrespective of reputation), or (2) in the denied list 136 (such a SYN packet would be dropped by the firewall device 102).

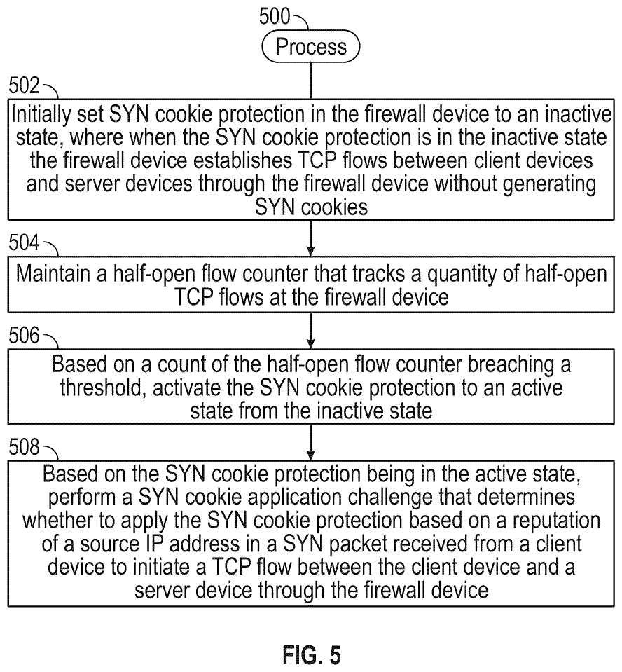

FIG. 5 is a flow diagram of a process 500 performed by a firewall device, such as the firewall device 102 of FIG. 1.

The process 500 includes initially setting (at 502) SYN cookie protection in the firewall device to an inactive state, where when the SYN cookie protection is in the inactive state the firewall device establishes TCP flows between client devices and server devices through the firewall device without generating SYN cookies.

The process 500 includes maintaining (at 504) a half-open flow counter that tracks a quantity of half-open TCP flows at the firewall device. An example of the half-open flow counter is depicted as 126 in FIG. 1.

The process 500 includes, based on a count of the half-open flow counter breaching a threshold, activating (at 506) the SYN cookie protection to an active state from the inactive state.

The process 500 includes, based on the SYN cookie protection being in the active state, performing (at 508) a SYN cookie application challenge that determines whether to apply the SYN cookie protection based on a reputation of a source IP address in a SYN packet received from a client device to initiate a TCP flow between the client device and a server device through the firewall device.

As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

A storage medium (e.g., 300 in FIG. 3 or 404 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a proxy device to:
track a count of how many half-open Transmission Control Protocol (TCP) flows are present in the proxy device; and
based on the count breaching a threshold, trigger activation, at the proxy device, of synchronize (SYN) cookie protection from an inactive state, wherein the SYN cookie protection comprises generating an initial sequence number for a synchronize-acknowledge (SYN-ACK) packet based on applying a function on TCP state information associated with a received SYN packet from a client device, the SYN packet to initiate a TCP flow between the client device and a server device, and the SYN-ACK packet sent by the proxy device to the client device in response to the SYN packet.

2. The non-transitory machine-readable storage medium of claim 1, wherein the instructions upon execution cause the proxy device to:
detect a half-open TCP flow based on:
receiving a first SYN packet at the proxy device from a first source Internet Protocol (IP) address of the client device,
sending a responsive SYN-ACK packet from the server device, and
determining that an ACK packet responsive to the SYN-ACK packet has not been received at the proxy device.

3. The non-transitory machine-readable storage medium of claim 2, wherein the instructions upon execution cause the proxy device to:
detect the half-open TCP flow further based on determining that the proxy device has not received a reset within a specified time duration from a transmission time of the SYN-ACK packet.

4. The non-transitory machine-readable storage medium of claim 2, wherein the instructions upon execution cause the proxy device to:
advance the count responsive to detecting the half-open TCP flow.

5. The non-transitory machine-readable storage medium of claim 1, wherein the instructions upon execution cause the proxy device to:
maintain the SYN cookie protection in the inactive state at the proxy device responsive to the count not breaching the threshold,
wherein when the SYN cookie protection is in the inactive state, the proxy device allows a creation of a new TCP flow in response to receiving a SYN packet.

6. The non-transitory machine-readable storage medium of claim 1, wherein the instructions upon execution cause the proxy device to:
access a configuration parameter representing a half-open TCP flow inactive timeout duration; and
terminate a given half-open TCP flow based on the given half-open TCP flow being inactive for the half-open TCP flow inactive timeout duration.

7. The non-transitory machine-readable storage medium of claim 1, wherein the instructions upon execution cause the proxy device to:
maintain first reputation information for source Internet Protocol (IP) addresses, the first reputation information correlating the source IP addresses to respective reputation indicators; and
update a first reputation indicator for a first source IP address in the first reputation information based on a quantity of consecutive full TCP flows established with the first source IP address or a quantity of consecutive non-established TCP flows with the first source IP address.

8. The non-transitory machine-readable storage medium of claim 7, wherein the updating of the first reputation indicator comprises setting the first reputation indicator to indicate a positive reputation for the first source IP address responsive to detecting a specified quantity of consecutive full TCP flows established with the first source IP address.

9. The non-transitory machine-readable storage medium of claim 8, wherein the instructions upon execution cause the proxy device to:
allow a creation of a new TCP flow with the first source IP address responsive to the first reputation indicator indicating the positive reputation.

10. The non-transitory machine-readable storage medium of claim 8, wherein the updating of the first reputation indicator comprises setting the first reputation indicator to indicate a negative reputation for the first source IP address responsive to detecting a specified quantity of consecutive non-established TCP flows with the first source IP address.

11. The non-transitory machine-readable storage medium of claim 10, wherein the instructions upon execution cause the proxy device to:
drop a SYN packet from the first source IP address responsive to the first reputation indicator indicating the negative reputation.

12. The non-transitory machine-readable storage medium of claim 10, wherein the instructions upon execution cause the proxy device to:
add the first source IP address to a denied list of source IP addresses responsive to the first reputation indicator indicating the negative reputation.

13. The non-transitory machine-readable storage medium of claim 7, wherein the updating of the first reputation indicator comprises setting the first reputation indicator to indicate an unknown reputation for the first source IP address, and wherein the instructions upon execution cause the proxy device to:
apply SYN cookie protection for a SYN packet received from the first source IP address if the first reputation indicator is set to indicate the unknown reputation.

14. The non-transitory machine-readable storage medium of claim 7, wherein the instructions upon execution cause the proxy device to:
maintain second reputation information that correlates source IP addresses to respective reputation indicators based on information from one or more IP reputation services; and
use the second reputation information to determine whether to:
allow creation of a new TCP flow with the first source IP address, or
apply SYN cookie protection for a SYN packet received from the first source IP address, or
drop the SYN packet from the first source IP address.

15. The non-transitory machine-readable storage medium of claim 1, wherein the instructions upon execution cause the proxy device to:
determine whether a quantity of generated SYN cookies has exceeded a threshold; and
based on determining that the quantity of generated SYN cookies has exceeded the threshold, drop a SYN packet.

16. The non-transitory machine-readable storage medium of claim 1, wherein the threshold is a first threshold, and wherein the instructions upon execution cause the proxy device to:
based on the count being greater than a second threshold but less than the first threshold, activate rapid aging of a half-open TCP flow established in response to a SYN packet, wherein the rapid aging reduces a flow inactivity timeout value that triggers termination of the half-open TCP flow if the half-open TCP flow has been inactive for a time duration represented by the flow inactivity timeout value.

17. A proxy device comprising:
a processor; and
a non-transitory storage medium comprising instructions executable on the processor to:
initially set synchronize (SYN) cookie protection in the proxy device to an inactive state;
detect a half-open Transmission Control Protocol (TCP) flow;
advance a half-open flow counter based on detecting the half-open TCP flow;
based on a count of the half-open flow counter breaching a threshold, activate the SYN cookie protection to an active state from the inactive state; and
based on the SYN cookie protection being in the active state, perform a SYN cookie application challenge that determines whether to apply the SYN cookie protection based on a reputation of a source Internet Protocol (IP) address in a SYN packet received from a client device to initiate a TCP flow between the client device and a server device.

18. The proxy device of claim 17, wherein the instructions are executable on the processor to:
based on the SYN cookie protection being in the active state, perform the SYN cookie application challenge that determines whether to apply the SYN cookie protection further based on whether a threshold on a quantity of SYN cookies is violated.

19. A method comprising:
initially setting, by a firewall device, synchronize (SYN) cookie protection in the firewall device to an inactive state, wherein when the SYN cookie protection is in the inactive state the firewall device establishes Transmission Control Protocol (TCP) flows between client devices and server devices without generating SYN cookies;
maintaining, at the firewall device, a half-open flow counter that tracks a quantity of half-open TCP flows at the firewall device;
based on a count of the half-open flow counter breaching a threshold, activating, by the firewall device, the SYN cookie protection to an active state from the inactive state; and
based on the SYN cookie protection being in the active state, performing, by the firewall device, a SYN cookie application challenge that determines whether to apply the SYN cookie protection based on a reputation of a source Internet Protocol (IP) address in a SYN packet received from a client device to initiate a TCP flow between the client device and a server device.

20. The method of claim 19, comprising:
determining, by the firewall device, the reputation of the source IP address based on one or more of internal IP reputation information or external IP reputation information.
